(19) United States
(12) Patent Application Publication
(10) Pub. No.: US 2005/0162380 A1
(43) Pub. Date: Jul. 28, 2005

(54) Laser sensitive screen

(76) Inventors: Jim Paikattu, Missouri City, TX (US); Chi So, Houston, TX (US); Juan Ignacio Martinez, Tomball, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/766,353

(22) Filed: Jan. 28, 2004

(51) Int. Cl. G09G 5/00

(52) U.S. Cl. 345/156

(57) ABSTRACT

In one embodiment, an input device is provided. The input device has, for example, a substrate, an array of optical sensors disposed on the substrate, and an array of conductive traces disposed on the substrate. The optical sensor array includes, for example, at least a first optical sensor defining at least one row element and at least one column element. The conductive trace array includes, for example, at least a first conductive trace defining a row signal pathway and at least a second conductive trace defining a column signal pathway. The array of optical sensors generate signals on the array of conductive traces upon excitation by electromagnetic radiation.

### BACKGROUND

User interfaces allow humans to interact with computer systems. One common user interface involves using a “mouse”-type input device to control a position of a cursor on a display of a computer system. Other types of input devices include trackballs that can be rotated to control a position of a cursor on a screen, touchpads and touch screens that can be physically touched by a user to control the position of a cursor on a screen, and joysticks that can be pushed to control the position of a cursor on a screen. While these are all important ways of interfacing to a computer system, it is desirable to provide additional ways of providing an user interface.

### SUMMARY

In one embodiment, an input device is provided. The input device has, for example, a substrate, an array of optical sensors disposed on the substrate, and an array of conductive traces disposed on the substrate. The optical sensor array includes, for example, at least a first optical sensor defining at least one row element and at least one column element. The conductive trace array includes, for example, at least a first conductive trace defining a row signal pathway and at least a second conductive trace defining a column signal pathway. The array of optical sensors generate signals on the array of conductive traces upon excitation by electromagnetic radiation.

### BRIEF DESCRIPTION OF THE DRAWINGS

FIG. 1 is an exemplary overall system diagram in accordance with one embodiment of the present invention;

FIG. 2 is an embodiment of an input device and associated components;

FIG. 3 is one embodiment of a pixel;

FIG. 4 is another embodiment of a pixel;

FIG. 5 is one embodiment of a display incorporating an input device.

FIG. 6 is one embodiment of a display in combination with an external input device.

### DETAILED DESCRIPTION OF ILLUSTRATED EMBODIMENTS

The following includes definitions of exemplary terms used throughout the disclosure. Both singular and plural forms of all terms fall within each meaning:

“Signal”, as used herein includes, but is not limited to, one or more electrical signals, analog or digital signals, one or more computer instructions, a bit or bit stream, or the like.

“Logic”, synonymous with “circuit” as used herein includes, but is not limited to, hardware, firmware, software and/or combinations of each to perform a function(s) or an action(s). For example, based on a desired application or needs, logic may include a software controlled microprocessor, discrete logic such as an application specific integrated circuit (ASIC), or other programmed logic device. Logic may also be fully embodied as software.

“Optical sensor” includes, but is not limited to, any device or circuit or combination of devices or circuits in which incident light regulates the response of the device(s) or circuit(s). For example, optical sensors can include phototransistors, photodiodes, photocells, photocell relays, or photodetectors.

“Substrate” includes, but is not limited to, any underlying support, foundation, or physical material on which a circuit is fabricated and can include, for example, ceramic, glass, plastic, semiconductor and ferrite.

“Transparent” as used herein includes, but is not limited to, for example, having the property of transmitting light without appreciable scattering or absorption so that bodies or objects lying beyond are seen clearly; allowing the passage of a specified form of radiation; or fine or sheer enough to be seen through.

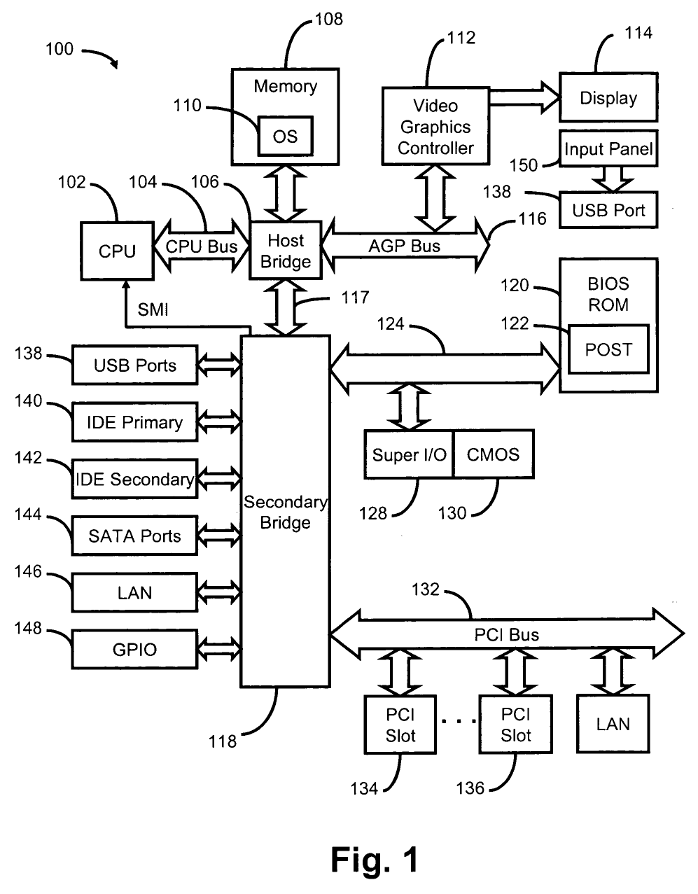

Referring now to FIG. 1, a computer system 100 constructed in accordance with one embodiment generally includes a central processing unit (“CPU”) 102 coupled to a host bridge logic device 106 over a CPU bus 104. CPU 102 may include any processor suitable for a computer such as, for example, a Pentium class processor provided by Intel. A system memory 108, which may be is one or more synchronous dynamic random access memory (“SDRAM”) devices (or other suitable type of memory device), couples to host bridge 106 via a memory bus. Further, a graphics controller 112, which provides video and graphics signals to a display 210, couples to host bridge 106 by way of a suitable graphics bus, such as the Advanced Graphics Port (“AGP”) bus 116. Host bridge 106 also couples to a secondary bridge 118 via bus 117.

A display 114 may be a Cathode Ray Tube, liquid crystal display or any other similar visual output device. An input device 150 is also provided and serves as an user interface to the system. As will be described in more detail, input device 150 may be a light sensitive panel for receiving commands from an user such as, for example, navigation of a cursor control input system. Input device 150 interfaces with the computer system's I/O such as, for example, USB port 138. Alternatively, input device 150 can interface with other I/O ports.

Secondary Bridge 118 is an I/O controller chipset. The secondary bridge 118 interfaces a variety of I/O or peripheral devices to CPU 102 and memory 108 via the host bridge 106. The host bridge 106 permits the CPU 102 to read data from or write data to system memory 108. Further, through host bridge 106, the CPU 102 can communicate with I/O devices on connected to the secondary bridge 118 and, and similarly, I/O devices can read data from and write data to system memory 108 via the secondary bridge 118 and host bridge 106. The host bridge 106 may have memory controller and arbiter logic (not specifically shown) to provide controlled and efficient access to system memory 108 by the various devices in computer system 100 such as CPU 102 and the various I/O devices. A suitable host bridge is, for example, a Memory Controller Hub such as the Intel® 875P Chipset described in the Intel® 82875P (MCH) Datasheet, which is hereby fully incorporated by reference.

Referring still to FIG. 1, secondary bridge logic device 118 may be an Intel® 82801EB I/O Controller Hub 5 (ICH5)/Intel® 82801ER I/O Controller Hub 5 R (ICH5R) device provided by Intel and described in the Intel® 82801EB ICH5/82801ER ICH5R Datasheet, which is incorporated herein by reference in its entirety. The secondary bridge includes various controller logic for interfacing devices connected to Universal Serial Bus (USB) ports 138, Integrated Drive Electronics (IDE) primary and secondary channels (also known as parallel ATA channels or sub-system) 140 and 142, Serial ATA ports or sub-systems 144, Local Area Network (LAN) connections, and general purpose I/O (GPIO) ports 148. Secondary bridge 118 also includes a bus 124 for interfacing with BIOS ROM 120, super I/O 128, and CMOS memory 130. Secondary bridge 118 further has a Peripheral Component Interconnect (PCI) bus 132 for interfacing with various devices connected to PCI slots or ports 134-136. The primary IDE channel 140 can be used, for example, to coupled to a master hard drive device and a slave floppy disk device (e.g., mass storage devices) to the computer system 100. Alternatively or in combination, SATA ports 144 can be used to couple such mass storage devices or additional mass storage devices to the computer system 100.

The BIOS ROM 120 includes firmware that is executed by the CPU 102 and which provides low level functions, such as access to the mass storage devices connected to secondary bridge 118. The BIOS firmware also contains the instructions executed by CPU 102 to conduct System Management Interrupt (SMI) handling and Power-On-Self-Test (“POST”) 122. POST 102 is a subset of instructions contained with the BIOS ROM 102. During the boot up process, CPU 102 copies the BIOS to system memory 108 to permit faster access.

The super I/O device 128 provides various inputs and output functions. For example, the super I/O device 128 may include a serial port and a parallel port (both not shown) for connecting peripheral devices that communicate over a serial line or a parallel pathway. Super I/O device 108 may also include a memory portion 130 in which various parameters can be stored and retrieved. These parameters may be system and user specified configuration information for the computer system such as, for example, an user-defined computer set-up or the identity of bay devices. The memory portion 130 in National Semiconductor's 97338VJG is a complementary metal oxide semiconductor (“CMOS”) memory portion. Memory portion 130, however, can be located elsewhere in the system.

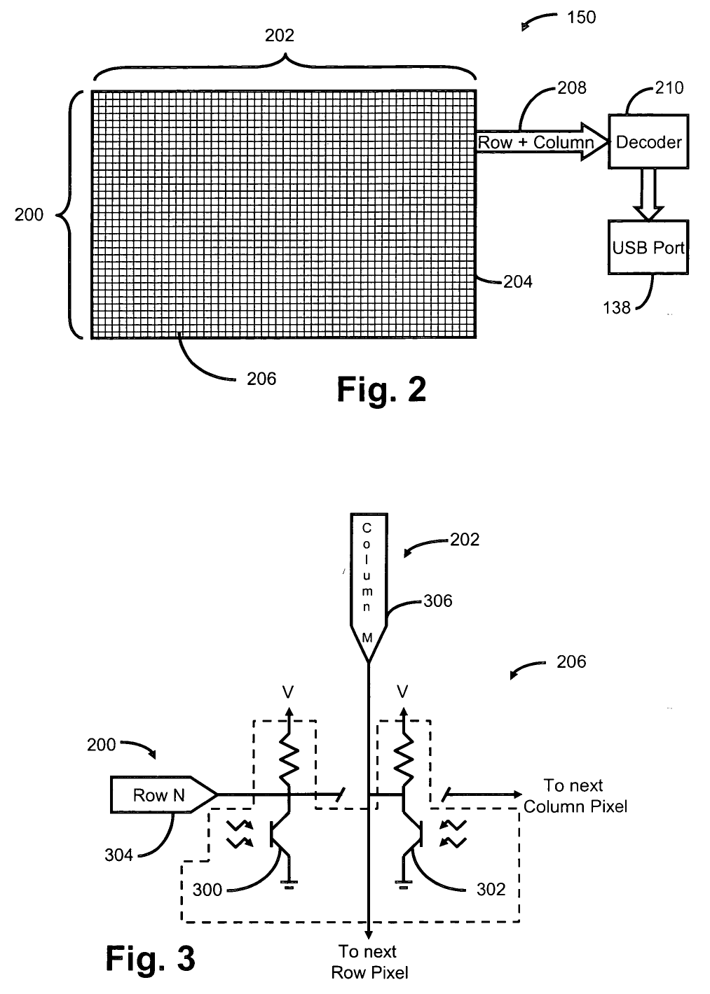

Referring now to FIG. 2, one embodiment of input device 150 in shown. Input device 150 includes a substrate 204 having an array of conductive traces 200 representing row information and an array of conductive traces 202 representing column information. Substrate 204 is may be made of a transparent or optically clear material such as, for example, glass. Other transparent or optically clear materials can also be used such as, for example, plastics or acrylics. The row conductive traces 200 and the column conductive traces 202 connect to pixels such as, for example, pixel 206. The number of rows and columns on substrate 204 can be any desired value. For example, one set of values can correspond to a display device's screen resolution (e.g., 800×600). Other possible values include those that are higher or lower than the screen resolution or values that are based on spatial separation such as by inch or millimeter increments. The input device 150 may have a length and width dimension that is substantially the same as the length and width dimension of the screen, or larger or smaller.

Substrate 204 also includes an array of conductive traces associated with a first or source of voltage level and an array of conductive traces associated with a second or ground voltage level, which also are connected to pixels 206.

Pixel 206 is representative of all of the pixels on input device 150 and one embodiment thereof is shown in more detail in FIG. 3. In this embodiment, pixel 206 has first and second optical sensor 300 and 302. Optical sensors 300 and 302 may be phototransistors that can be excited by a range of electromagnetic energy so as to either be conductive or non-conductive between their terminals. Other types of optical sensors can also be used.

In particular, optical sensors 300 and 302 can act as open circuits that do not conduct electricity or signals between their terminals when they are in their normal or unexcited state. Upon excitation by electromagnetic energy such as, for example, when light of a particular wavelength or wavelengths is incident on the sensors, they act as closed circuits that conduct electricity or signals between their terminals. The electromagnetic energy causing this effect can be light in the visible or invisible (e.g., infra-red) spectrum. Alternatively, optical sensors 300 and 302 can be fabricated to work in the reverse manner with respect to incident electromagnetic energy.

Optical sensor 300 includes two terminals. A first terminal is connected to a Row N node 304. The Row N node 304 is part of the array of conductive traces on substrate 204 that represent row information. The Row N node 304 is also connected to one side of a pull-up resistor, which is in turn connected to the array of conductive traces associated with the first voltage level V. As shown, the Row N node 304 can represent any row of substrate 204 (i.e., N=1, 2, 3, . . . etc.) A second terminal of optical sensor 300 is connected to the array of conductive traces associated with the second or ground voltage level. Optical sensor 302 is similarly constructed, except that its first terminal is connected to a Column M node 306. The Column M node 306 is part of the array of conductive traces on substrate 204 that represent column information. As shown, the Column M node 306 can represent any column of substrate 204 (i.e., M=1, 2, 3, . . . etc.)

In operation, optical sensors 300 and 302 are normally in their open circuit state (i.e., not conducting) when not excited by electromagnetic energy of the proper wavelength(s). Hence, Row N node 304 and Column M node 306 will be at the first voltage level V. Upon excitation by electromagnetic energy of the proper wavelength(s), optical sensors 300 and 302 will change to their closed circuit states (i.e., conducting) and cause Row N node 304 and Column M node 306 to be at the second or ground voltage level. This excitation can occur, for example, by shining an optical pointer or laser pointer device upon a portion of substrate 204 and, hence, on one or more pixels 206. Upon a loss of excitation, optical sensors 300 and 302 will revert back to their open circuit state (i.e., not conducting) and cause Row N node 304 and Column M node 306 to be at the first voltage level V.

Referring now back to FIG. 2, the state of Row N node 304 and Column M node 306 is communicated to a decoder 210 over a bus 208. Decoder 208 decodes the row and column node states into pixel information that is communicated to a computer system's I/O system for processing. This processing can include coordinating the position of a cursor on a display or monitor.

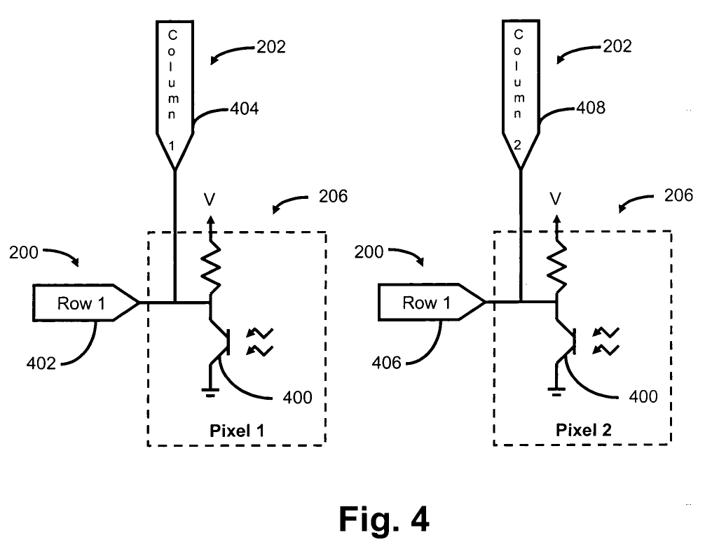

Shown in FIG. 4 is a second embodiment of pixel 206. In this embodiment, pixel 206 includes a single optical sensor 400. Optical sensor 400 operates in a similar manner to optical sensors 300 and 302 of FIG. 3, except that optical sensor 400 has a common node for row and column information that is not shared by any other pixel. In particular, the embodiment of FIG. 4 shows two such side-by-side pixels (Pixel 1 and Pixel 2) of input device 150. Pixel 1, which occupies the (1,1) position in the input device 150, has its own Row 1 trace 402 and Column 1 trace 404 that form a common node with the first terminal of optical sensor 400. Pixel 2, which occupies the (1,2) position in the input device 150, has its own Row 1 trace 406 and Column 2 trace 408 that form a common node. Row 1 trace 402 and Row 1 trace 406 are not on a common node. When Pixel 1 is excited by electromagnetic energy, its output designates a Row 1 and Column 1 position to decoder 210 (FIG. 2). When Pixel 2 is excited by electromagnetic energy, its output designates a Row 1 and Column 2 position to decoder 210 (FIG. 2). Hence, the embodiment of FIG. 4 includes dedicated Row and Column traces to each pixel.

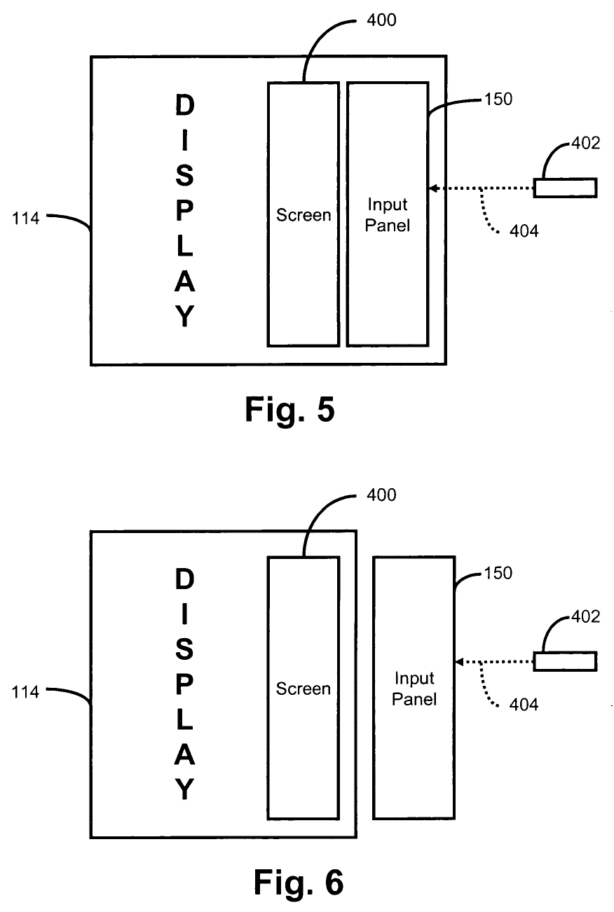

Illustrated in FIG. 5 is one embodiment of a display 114 that incorporates input device 150 within a common housing. Input device 150 is disposed proximate a display screen 400 and may be in front thereof. A source of electromagnetic energy 402 such as, for example, a laser pointer, can then be used to impart light upon input device 150 to excite one or more pixels thereon. In all embodiments, the array of conductive traces and optical sensors are fabricated on a micro-level so as to not obscure the screen 400 behind the input device. In this manner, they remain substantially invisible to the user and graphical images (e.g., cursors or pointers) or information generated by display screen 400 can be emitted and transmitted through transparent substrate 204 of input device 150 back to the user for viewing.

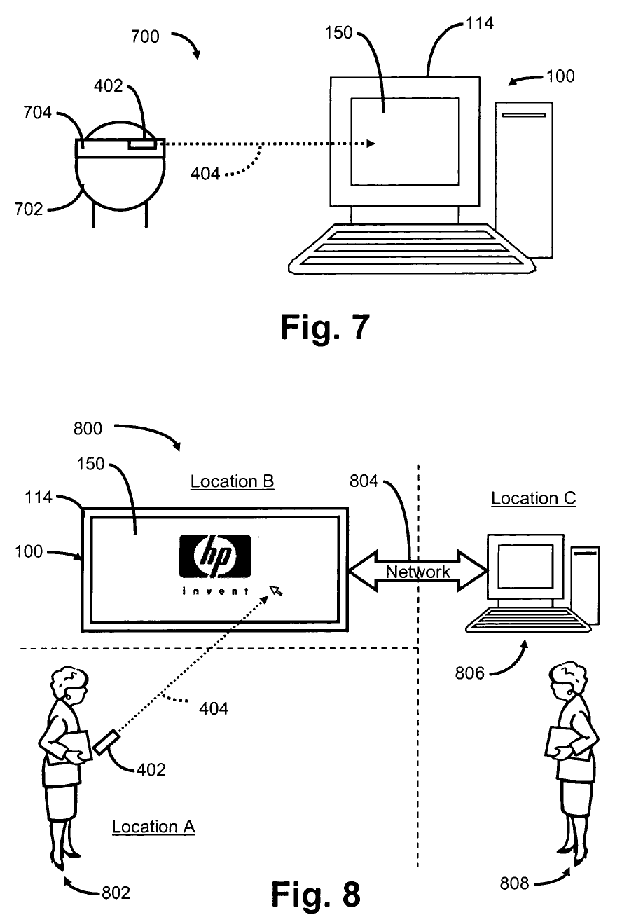

Illustrated in FIG. 6 is one embodiment of a display 114 that is used in combination with an external input device 150. Input device 150 is disposed proximate the display screen 400 and may be in front thereof. Input device 150 can be appropriately secured to the housing of display 114 or affixed to a mount or stand to effectuate the aforementioned position. A source of electromagnetic energy 402 such as, for example, a laser pointer, can then be used to impart light upon the external input device 150 to excite one or more pixels thereon. As described earlier, graphical images or information generated by display screen 400 can be emitted and transmitted through transparent substrate 204 of input device 150 back to the user for viewing.

Independent of whether input panel 150 is incorporated within display 114 or external thereto, system 100 (FIG. 1) associates the location of the beam of electromagnetic energy 404 on input panel 150 with the location with a position of a cursor or pointer generated on display 114. For example, system 100 may be configured so that the cursor or pointer is generated on screen 114 at a position that is direct behind the location of the beam 404 incident on input panel 150. Since input panel 150 is fabricated on a transparent substrate, the cursor or pointer image generated behind it will be transmitted through the input panel's substrate and will be viewable to the user. From the user's perspective, the location of the beam on the panel and the cursor or pointer associated there with will appear to be co-located at the same position.

Referring now to FIG. 7, system 700 is illustrated showing the use of a head-mounted source or emitter of electromagnetic energy such as, for example, a head-mounted laser pointer. The system includes a strap, head harness or similar attachment for mounting the emitter or pointer 402 to the head of a user 702. Movement of the user's head can direct or steer the beam of electromagnetic energy 404 onto input device 150, which may be used to control computer system 100. This system provides a manner in which handicapped users can access and control their computer systems without the need for the use of their hands or structures including tables or other surfaces that are required for typical computer input devices.

FIG. 8 illustrates a system 800 allowing for very remote actuation or control of a cursor or pointer device. Such a system may be used in connection with, for example, large class rooms, conference rooms or auditoriums. Locations A, B and C can within a very large room and separated by many meters or yards. Also, locations A and B can within a very large room and separated by many meters of yards and location C can completely remote therefrom such as, for example, in a different room, building or facility. A teacher, lecturer or speaker 802 can be situated at location A and direct a beam of electromagnetic energy 404 to system 100, which is situated at the distant location B through a laser pointer or emitter 402. System 100 may include a very large display 114 for displaying the speaker's materials and the input device 150 superposed thereon for sensing the location of the beam. As described earlier, system 100 associates the location of the beam on input device 150 with a location of a cursor or pointer generated on display 114. System 100 may be further connected to a network 804 for local or remote transmission of the cursor or pointer information to remote computer systems 806 (Location C) where students or other individuals 808 can monitor or observe the cursor movements.

While the present invention has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. For example, the input device 150 can integrated into the fabrication of a display so as to reside on a common substrate with the display elements. Thereby, a pixel can include a combination or optical or light-emitting elements and optical sensing elements. Therefore, the invention, in its broader aspects, is not limited to the specific details, the representative apparatus, and illustrative examples shown and described. Accordingly, departures may be made from such details without departing from the spirit or scope of the applicant's general inventive concept.

1. An input device comprising:
a transparent substrate;
an array of optical sensors disposed on the substrate, the optical sensor array comprising: at least a first optical sensor defining at least one row element and at least a second optical sensor defining at least one column element;
an array of conductive traces disposed on the substrate, the conductive trace array comprising: at least a first conductive trace defining a row signal pathway and at least a second conductive trace defining a column signal pathway; and
wherein the array of optical sensors generate signals on the array of conductive traces upon excitation by electromagnetic radiation.

2. The input device of claim 1 wherein the first optical sensor comprises an output defining a row signal.

3. The input device of claim 1 wherein the second optical sensor comprises an output defining a column signal.

4. The input device of claim 2 wherein the second optical sensor comprises an output defining a column signal.

5. The input device of claim 1 wherein the substrate comprises a material having glass.

6. The input device of claim 1 wherein the electromagnetic radiation comprises visible light.

7. The input device of claim 1 wherein the electromagnetic radiation comprises infra-red light.

8. The input device of claim 1 wherein the first or second optical sensors comprise an output defining a row or column first state and a row or column second state.

9. The input device of claim 8 wherein the first state comprises a first signal level.

10. The input device of claim 9 wherein the second state comprises a second signal level.

11. A display comprising:
a screen for displaying images; and
an input device comprising:
a transparent substrate;
an array of optical sensors disposed on the substrate, the optical sensor array comprising: at least a first optical sensor defining at least one row element and at least a second optical sensor defining at least one column element;
an array of conductive traces disposed on the substrate, the conductive trace array comprising: at least a first conductive trace defining a row signal pathway and at least a second conductive trace defining a column signal pathway; and
wherein the array of optical sensors generate signals on the array of conductive traces upon excitation by electromagnetic radiation.

12. The display of claim 11 wherein the first optical sensor comprises an output having a row signal and wherein the row signal comprises a first and second state.

13. The display of claim 12 wherein the second optical sensor comprises an output having a column signal and wherein the column signal comprises a first and second state.

14. The display of claim 11 wherein the row signal switches from the first to the second state upon electromagnetic excitation of the first optical sensor.

15. The display of claim 14 wherein the column signal switches from the first to the second state upon electromagnetic excitation of the second optical sensor.

16. The display of claim 11 further comprising a row and column output.

17. A computer system comprising:
a computer; and
a display comprising:
a screen for displaying images; and
an input device comprising:
a transparent substrate;
an array of optical sensors disposed on the substrate, the optical sensor array comprising: at least a first optical sensor defining at least one row element and at least a second optical sensor defining at least one column element;
an array of conductive traces disposed on the substrate, the conductive trace array comprising: at least a first conductive trace defining a row signal pathway and at least a second conductive trace defining a column signal pathway; and
wherein the array of optical sensors generate signals on the array of conductive traces upon excitation by electromagnetic radiation.

18. The display of claim 17 wherein the first optical sensor comprises an output having a row signal and wherein the row signal comprises a first and second state.

19. The display of claim 18 wherein the second optical sensor comprises an output having a column signal and wherein the column signal comprises a first and second state.

20. The display of claim 11 wherein the row signal switches from the first to the second state upon electromagnetic excitation of the first optical sensor.

21. The display of claim 14 wherein the column signal switches from the first to the second state upon electromagnetic excitation of the second optical sensor.

22. An input device comprising:
a transparent substrate;
an array of optical sensors disposed on the substrate, the optical sensor array comprising: at least a first optical sensor defining at least one row element and at least one column element;
an array of conductive traces disposed on the substrate, the conductive trace array comprising: at least a first conductive trace defining a row signal pathway and at least a second conductive trace defining a column signal pathway; and
wherein the array of optical sensors generate signals on the array of conductive traces upon excitation by electromagnetic radiation.

23. An input device comprising:
transparent substrate means;
optical sensing means disposed on the substrate means and defining at least one row element and at least one column element;
row signal means and column signal means disposed on the substrate means; and
wherein the optical sensing means generates signals on the row signal means and column signal means upon excitation by electromagnetic radiation.

24. A remotely actuatable cursor device comprising:
a pointer for generating a beam of electromagnetic radiation;
a sensing panel located substantially remotely from the pointer configured to sense the beam of electromagnetic radiation;
a computer in circuit communication with the sensing panel configured to associate the sensing of the beam of electromagnetic radiation by the sensing panel with a position of a cursor on a display associated with the computer.

25. The device of claim 24 wherein the sensing panel comprises a length and a width and wherein the length and width have a dimension that at least equivalent to a portion of a screen of the display.

26. The device of claim 24 further comprising a head harness or mount for attaching the pointer to the head of a user.

27. The device of claim 24 wherein the sensing panel comprises a transparent substrate.

28. The device of claim 24 wherein the sensing panel is superposed on the display.

29. A method of controlling a cursor or pointer comprising:
emitting a beam of electromagnetic energy;
sensing a location of the beam on an input panel having a transparent substrate;
associating the location of the beam on the input panel with a cursor or pointer displayed on a screen.

30. The method of claim 29 further comprising the step of displaying an image of a cursor or pointer substantially behind the location of the beam on the input panel.

31. The method of claim 29 further comprising generating an image of a cursor or pointer on a display and transmitting the image through the input panel at a position corresponding to the location of the beam on the input panel.

32. A method of remotely controlling a cursor or pointer comprising:
emitting a beam of electromagnetic energy from a pointer device situated at a first location;
sensing a location of the beam on an input panel located situated at a second position distant from the first position; and
associating the location of the beam on the input panel with a cursor or pointer displayed on a screen situated at a third location.

33. The method of claim 32 wherein emitting a beam of electromagnetic energy from a pointer device situated at a first location comprises emitting a beam of electromagnetic radiation for a pointer device attached to the head of a user.

34. A system for remotely controlling a cursor or pointer comprising:
means for emitting a beam of electromagnetic energy;
substantially transparent means for sensing a location of the beam; and
means for associating the location of the beam on the means for sensing with a cursor or pointer displayed on a display means.
